(19) United States
(12) Patent Application Publication
(10) Pub. No.: US 2026/0282114 A1
(43) Pub. Date: Sep. 17, 2026

(54) WIRELESS COMMUNICATION METHOD, TERMINAL DEVICE, AND NETWORK DEVICE

(71) Applicant: QUECTEL WIRELESS SOLUTIONS CO., LTD., Shanghai (CN)

(72) Inventors: Ling LYU, Frisco, TX (US); Zheng ZHAO, Shanghai (CN)

(21) Appl. No.: 19/676,584

(22) Filed: May 13, 2026

Related U.S. Application Data
(63) Continuation of application No. PCT/CN2024/124567, filed on Oct. 12, 2024.

(51) Int. Cl. H04W 74/0838; H04W 64/00; H04W 72/0457; H04W 74/00

(52) U.S. Cl. CPC H04W 74/0838; H04W 64/00; H04W 72/0457; H04W 74/006

(57) ABSTRACT

Disclosed are a wireless communication method, a terminal device, and a network device. One example method includes: receiving, by a terminal device, first information, wherein the first information is related to a trigger request of a target on-demand system information block 1 (SIB1); transmitting, by the terminal device, a first request to a network device, wherein the first request is used to request the target on-demand SIB1; and receiving, by the terminal device, the target on-demand SIB1 from the network device, wherein the first information indicate at least one of a first preamble related to the first request, PRACH resources related to the first request, or a transmission resource of the target on-demand SIB1.

### CROSS-REFERENCE TO RELATED APPLICATIONS

This application is a continuation of International Application No. PCT/CN2024/124567, filed on Oct. 12, 2024, the disclosure of which is hereby incorporated by reference in its entirety.

### TECHNICAL FIELD

The present application relates to the field of communications technologies, and more specifically, to a wireless communication method, a terminal device, and a network device.

### BACKGROUND

In some communications systems, a network device periodically transmits a system information block (system information blocks, SIB) 1. The SIB1 carries key information required by a terminal device for accessing a cell. To save energy, the network device may further trigger SIB1 transmission based on a request of the terminal device. However, how to transmit the request by the terminal device and how to receive the SIB1 are both problems urgently to be resolved.

### SUMMARY

The present application provides a wireless communication method, a terminal device, and a network device. Various aspects of embodiments of the present application are described below.

According to a first aspect, a wireless communication method is provided, including: receiving, by a terminal device, first configuration information, where the first configuration information is related to a trigger request of a target SIB1; transmitting, by the terminal device, a first request to a network device, where the first request is used to request the target SIB1; and receiving, by the terminal device, the target SIB1 transmitted by the network device, where the first configuration information is used to indicate a first preamble related to the first request and/or a transmission resource of the target SIB1.

According to a second aspect, a wireless communication method is provided, including: transmitting, by a network device, first configuration information, where the first configuration information is related to a trigger request of a target SIB1; receiving, by the network device, a first request transmitted by a terminal device, where the first request is used to request the target SIB1; and transmitting, by the network device, the target SIB1 to the terminal device, where the first configuration information is used to indicate a first preamble related to the first request and/or a transmission resource of the target SIB1.

According to a third aspect, a terminal device is provided, including: a transceiver unit, receiving first configuration information, where the first configuration information is related to a trigger request of a target SIB1; the transceiver unit is further configured to transmit a first request to a network device, where the first request is used to request the target SIB1; the transceiver unit is further configured to receive the target SIB1 transmitted by the network device; and the first configuration information is used to indicate a first preamble related to the first request and/or a transmission resource of the target SIB1.

According to a fourth aspect, a network device is provided, including: a transceiver unit, transmitting first configuration information, where the first configuration information is related to a trigger request of a target SIB1; the transceiver unit is further configured to receive a first request transmitted by a terminal device, where the first request is used to request the target SIB1; the transceiver unit is further configured to transmit the target SIB1 to the terminal device; and the first configuration information is used to indicate a first preamble related to the first request and/or a transmission resource of the target SIB1.

According to a fifth aspect, a communications apparatus is provided, including a memory and a processor. The memory is configured to store a program. The processor is configured to invoke the program in the memory to perform the method according to the first aspect or the second aspect.

According to a sixth aspect, an apparatus is provided, including a processor invoking a program from a memory to perform the method according to the first aspect or the second aspect.

According to a seventh aspect, a chip is provided, including a processor invoking a program from a memory, to cause a device installed with the chip to perform the method according to the first aspect or the second aspect.

According to an eighth aspect, a computer-readable storage medium is provided, where the computer-readable storage medium stores a program, and the program causes a computer to perform the method according to the first aspect or the second aspect.

According to a ninth aspect, a computer program product is provided, including a program. The program causes a computer to perform the method according to the first aspect or the second aspect.

According to a tenth aspect, a computer program is provided. The computer program causes a computer to perform the method according to the first aspect or the second aspect.

In embodiments of the present application, a terminal device may determine, based on first configuration information, a first preamble when a first request is transmitted based on random access, or may determine a transmission resource of a target SIB1 based on the first configuration information. The target SIB1 is a SIB1 transmitted on demand. It can be learned that, by setting the first configuration information, the terminal device can more conveniently request the target SIB1 from the network device and receive the target SIB1 in a timely manner, thereby implementing network energy saving and improving resource utilization.

### BRIEF DESCRIPTION OF THE DRAWINGS

FIG. 1 shows a wireless communications system to which embodiments of the present application are applied.

FIG. 2 is a schematic diagram of a wireless communication scenario to which embodiments of the present application are applied.

FIG. 3 is a schematic flowchart of a wireless communication method according to an embodiment of the present application.

FIG. 4 is a schematic diagram of a possible implementation of the method shown in FIG. 3.

FIG. 5 is a schematic diagram of a possible procedure of the method shown in FIG. 3.

FIG. 6 is a schematic structural diagram of a terminal device according to an embodiment of the present application.

FIG. 7 is a schematic structural diagram of a network device according to an embodiment of the present application.

FIG. 8 is a schematic structural diagram of a wireless communications apparatus according to an embodiment of the present application.

### DETAILED DESCRIPTION OF THE EMBODIMENTS

The following describes the technical solutions in embodiments of the present application with reference to the accompanying drawings.

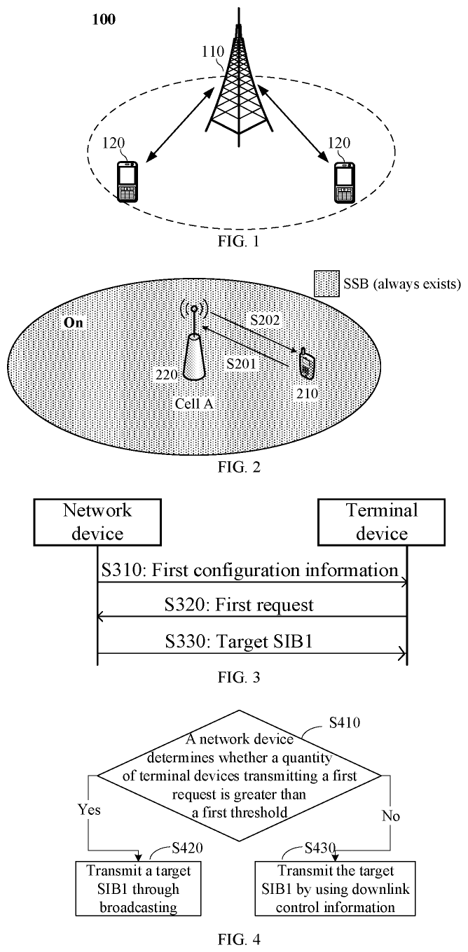

FIG. 1 is a schematic diagram of an architecture of a wireless communications system 100 to which embodiments of the present application are applied. As shown in FIG. 1, the wireless communications system 100 may include a network device 110 and a terminal device 120. The network device 110 may be a device that communicates with the terminal device 120. The network device 110 may provide communication coverage in a specific geographic area, and may communicate with a terminal device located in the coverage area.

FIG. 1 exemplarily shows one network device and two terminal devices. Optionally, the wireless communications system 100 may include a plurality of network devices, and another quantity of terminal devices may be included in coverage of each network device, which is not limited.

In embodiments of the present application, the wireless communications system shown in FIG. 1 may further include other network entities such as a mobility management entity (mobility management entity, MME), or an access and mobility management function (access and mobility management function, AMF), and a network controller, which is not limited in embodiments of the present application.

It should be understood that embodiments of the present application may be applied to various communications systems. For example, embodiments of the present application may be applied to a global system for mobile communications (global system of mobile communication, GSM), a code division multiple access (code division multiple access, CDMA) system, a wideband code division multiple access (wideband code division multiple access, WCDMA) system, a general packet radio service (general packet radio service, GPRS) system, a long term evolution (long term evolution, LTE) system, an advanced long term evolution (advanced long term evolution, LTE-A) system, a new radio (new radio, NR) system, an evolved system of an NR system, an LTE-based access to unlicensed spectrum (LTE-based access to unlicensed spectrum, LTE-U) system, an NR-based access to unlicensed spectrum (NR-based access to unlicensed spectrum, NR-U) system, a universal mobile telecommunications system (universal mobile telecommunications system, UMTS), a wireless local area network (wireless local area networks, WLAN) system, a wireless fidelity (wireless fidelity, WiFi) system, and a 5th-generation (5th-generation, 5G) communications system. Embodiments of the present application may be further applied to another communications system, for example, a future communications system such as a 6th-generation (6th-generation, 6G) mobile communications system or a satellite (satellite) communications system.

Conventional communications systems support a limited quantity of connections and are easy to implement. However, with development of communications technologies, a communications system may support not only conventional cellular communications but also one or more other types of communications. For example, the communications system may support one or more types of the following communication: device-to-device (device to device, D2D) communication, machine-to-machine (machine to machine, M2M) communication, machine type communication (machine type communication, MTC), enhanced machine type communication (enhanced MTC, eMTC), vehicle-to-vehicle (vehicle to vehicle, V2V) communication, vehicle-to-everything (vehicle to everything, V2X) communication, and the like. Embodiments of the present application may also be applied to a communications system that supports the foregoing communication manners.

The communications system in embodiments of the present application may be applied to a carrier aggregation (carrier aggregation, CA) scenario, a dual connectivity (dual connectivity, DC) scenario, or a standalone (standalone, SA) networking scenario.

The communications system in embodiments of the present application may be applied to an unlicensed spectrum. The unlicensed spectrum may also be considered as a shared spectrum. Alternatively, the communications system in embodiments of the present application may be applied to a licensed spectrum. The licensed spectrum may also be considered as a dedicated spectrum.

Embodiments of the present application may be applied to a non-terrestrial network (non-terrestrial network, NTN) system. In an example, the NTN system may be a 4G-based NTN system, an NR-based NTN system, an NTN system based on an internet of things (internet of things, IoT), or an NTN system based on a narrow band internet of things (narrow band internet of things, NB-IoT).

The terminal device in embodiments of the present application may also be referred to as a user equipment (user equipment, UE), an access terminal, a subscriber unit, a subscriber station, a mobile site, a mobile station (mobile station, MS), a mobile terminal (mobile terminal, MT), a remote station, a remote terminal, a mobile device, a user terminal, a terminal, a wireless communications device, a user agent, a user apparatus, or the like.

In some embodiments, the terminal device in embodiments of the present application may be a device providing a user with voice and/or data connectivity and capable of connecting people, objects, and machines, such as a handheld device or a vehicle-mounted device having a wireless connection function. The terminal device in embodiments of the present application may be a mobile phone (mobile phone), a tablet computer (Pad), a notebook computer, a palmtop computer, a mobile Internet device (mobile internet device, MID), a wearable device, a virtual reality (virtual reality, VR) device, an augmented reality (augmented reality, AR) device, a wireless terminal in industrial control (industrial control), a wireless terminal in self driving (self driving), a wireless terminal in remote medical surgery (remote medical surgery), a wireless terminal in a smart grid (smart grid), a wireless terminal in transportation safety (transportation safety), a wireless terminal in a smart city (smart city), a wireless terminal in a smart home (smart home), or the like. Optionally, the UE may be configured to function as a base station. For example, the UE may function as a scheduling entity, which provides a sidelink signal between UEs in V2X, D2D, or the like. For example, a cellular phone and a vehicle communicate with each other by using a sidelink signal. A cellular phone and a smart home device communicate with each other, without relay of a communication signal through a base station.

In some embodiments, the terminal device may be a station (STATION, ST) in a WLAN. In some embodiments, the terminal device may be a cellular phone, a cordless phone, a session initiation protocol (session initiation protocol, SIP) phone, a wireless local loop (wireless local loop, WLL) station, a personal digital assistant (personal digital assistant, PDA) device, a handheld device with a wireless communication function, a computing device, or another processing device connected to a wireless modem, a vehicle-mounted device, a wearable device, a terminal device in a next-generation communications system (such as an NR system), a terminal device in a future evolved public land mobile network (public land mobile network, PLMN), or the like.

The network device in embodiments of the present application may be a device for communicating with the terminal device. The network device may also be referred to as an access network device or a wireless access network device. The network device may be, for example, a base station. The network device in embodiments of the present application may be a radio access network (radio access network, RAN) node (or device) that connects the terminal device to a wireless network. The base station may broadly cover various names in the following, or may be replaced with the following names: a NodeB (NodeB), an evolved NodeB (evolved NodeB, eNB), a next generation NodeB (next generation NodeB, gNB), a relay station, an access point, a transmitting and receiving point (transmitting and receiving point, TRP), a transmitting point (transmitting point, TP), a master eNode (MeNB), a secondary eNode (SeNB), a multi-standard radio (MSR) node, a home base station, a network controller, an access node, a wireless node, an access point (access point, AP), a transmission node, a transceiver node, a baseband unit (base band unit, BBU), a remote radio unit (remote radio unit, RRU), an active antenna unit (active antenna unit, AAU), a remote radio head (remote radio head, RRH), a central unit (central unit, CU), a distributed unit (distributed unit, DU), a positioning node, or the like. The base station may be a macro base station, a micro base station, a relay node, a donor node, or the like, or a combination thereof. Alternatively, the base station may be a communications module, a modem, or a chip disposed in the device or the apparatus described above. Alternatively, the base station may be a mobile switching center, a device that functions as a base station in D2D, V2X, or M2M communications, a network-side device in a 6G network, a device that functions as a base station in a future communications system, or the like. The base station may support networks of a same access technology or different access technologies. A specific technology and a specific device used by the network device are not limited in embodiments of the present application.

The base station may be a fixed or mobile base station. For example, a helicopter or an unmanned aerial vehicle may be configured to act as a mobile base station, and one or more cells may move based on a location of the mobile base station. In other examples, a helicopter or an unmanned aerial vehicle may be configured to function as a device in communication with another base station.

In some deployments, the network device in embodiments of the present application may be a CU or a DU, or the network device includes a CU and a DU. The gNB may further include an AAU.

The network device and the terminal device may be deployed on land, including being indoors or outdoors, handheld, or vehicle-mounted, may be deployed on a water surface, or may be deployed on a plane, a balloon, or a satellite in the air. In embodiments of the present application, a scenario of the network device and the terminal device is not limited.

It should be understood that all or a part of functions of the communications device in the present application may also be implemented by software functions running on hardware, or by virtualization functions instantiated on a platform (for example, a cloud platform).

In embodiments of the present application, the network device may provide a service for a cell. The terminal device communicates with the network device by using a transmission resource (for example, a frequency resource or a spectrum resource) used by the cell. The cell may be a cell corresponding to the network device (for example, a base station). The cell may belong to a macro station or may belong to a base station corresponding to a small cell (small cell). The small cell herein may include a metro cell (metro cell), a micro cell (micro cell), a pico cell (pico cell), a femto cell (femto cell), or the like. These small cells have characteristics of small coverage and low transmit power, and are suitable for providing a high-rate data transmission service.

It should be understood that a device having a communication function in a network/system in embodiments of the present application may be referred to as a communications device. The wireless communication system 100 shown in FIG. 1 is used as an example. The communications device may include a network device 110 and a terminal device 120 that have a communication function, and may further include another device in the wireless communications system 100, for example, another network entity such as a network controller or a mobility management entity, which is not limited in embodiments of the present application.

For ease of understanding, some relevant technical knowledge related to embodiments of the present application is first described. The following related technologies, as optional solutions, may be randomly combined with the technical solutions of embodiments of the present application, all of which fall within the protection scope of embodiments of the present application. Embodiments of the present application include at least a part of the following content.

With the development of mobile communications technologies, a next-generation evolved wireless system (for example, a 5G system) improves a data transmission rate by using a plurality of technologies to meet requirements of different scenarios. For example, the plurality of technologies include a large-scale multiple-input multiple-output (multiple-input multiple-output, MIMO) technology, a non-orthogonal multiple access technology, a co-time co-frequency full-duplex communications technology, a novel modulation technology, a novel encoding technology, and a high-order modulation technology.

In an example, a peak rate may reach a Gbit/s standard to meet a requirement of large-data-volume transmission such as a high-definition video and virtual reality.

In an example, a latency level of an air interface needs to be about 1 ms to meet real-time application such as autonomous driving and telemedicine.

In an example, an ultra-large network capacity can provide a connection capability of hundreds of billions of devices, thereby meeting an internet of things communication requirement.

In an example, spectral efficiency of an NR system is over 10 times higher than that of an LTE system. Based on continuous wide-area coverage and high mobility, an experience rate of a user can reach 100 Mbit/s. It may be learned that a traffic density and a connection density are increased greatly.

In addition, improvement of system collaboration and an intelligence level further improves flexibility of a network. System collaboration may be embodied as collaborative networking with a plurality of users, a plurality of points, a plurality of antennas, and a plurality of acquisitions. Based on collaboration and intelligence, automatic adjustment can be performed between networks flexibly.

However, in a communications system, power consumption of a network device (for example, a base station devices) is usually high. To reduce power consumption of the base station device, system information needs to be optimized. For ease of understanding, the following uses system information of NR as an example for description.

The system information of NR can be classified into master information block (master information block, MIB) messages and some SIB messages. A MIB message is usually sent on a broadcast channel (broadcast channel, BCH). A transmission periodicity of the MIB is 80 ms. The MIB may be repeatedly transmitted within a periodicity of 80 ms. In addition, the MIB message further includes a parameter required by the terminal device to obtain a SIB1 message from a cell.

The SIB1 message may also be referred to as a SIB type 1 message. The SIB1 is transmitted on a downlink shared channel (downlink-shared channel, DL-SCH) at a periodicity of 160 ms. Within 160 ms, the SIB may be further repeatedly transmitted with a variable transmission repetition periodicity. A default repetition transmission periodicity for the SIB1 is 20 ms. An actual repetition transmission periodicity depends on network implementation. For example, for a multiplexing mode 1 of a synchronization signal block (synchronization signal block, SSB) and a control resource set (control resource set, CORESET), the repetition transmission periodicity of the SIB1 is 20 ms. For another example, for a multiplexing mode 2/3 of the SSB and the CORESET, the repetition transmission periodicity of the SIB1 is the same as a periodicity of the SSB.

In this embodiment of the present application, the SSB may further represent a synchronization signal/physical broadcast channel block (synchronization signal and PBCH block).

The SIB1 may carry key information required by the terminal device to access a cell, for example, a random access parameter. The SIB1 may further carry information related to availability and scheduling of another SIB, for example, mapping from the another SIB to a system information (system information, SI) message, periodicity, SI window size, and the like. The SIB1 may further indicate whether one or more SIBs are provided only on demand. In this case, the SIB1 may further provide a physical random access channel (physical random access channel, PRACH) configuration required by the terminal device, so as to request SI required by the terminal device. The SIB1 further includes radio resource configuration information common to all terminal devices and cell barring information applied to unified access control.

When the SIB1 includes information related to another SIB, the another SIB message may be broadcast periodically or provided on demand. If the another SIB is provided on demand, the SIB1 may include information for the terminal device to execute a system information (system information, SI) request.

A SIB message (another SIB) other than the SIB1 may be included in the SI message. This message may also be transmitted on a DL-SCH. Each SI message may be periodically transmitted within a time domain window (referred to as an SI window). Only SIBs with a same periodicity can be mapped to a same SI message. Each SI message is transmitted within a time domain window that occurs periodically (All SI messages may have SI windows of a same length). Each SI message is associated with an SI window, and SI windows of different SI messages do not overlap. In other words, only a corresponding SI message is transmitted in one SI window. In addition, a system may transmit the SI message a plurality of times within the SI window.

As described above, in a conventional communications system, a network device (for example, a gNB) may periodically transmit a SIB1 for initial access and schedule another SIB of a terminal device in an idle (idle)/inactive (inactive, also referred to as inactive) mode. The network device always performs transmission even if there is no demand from the terminal device or no terminal device camps on a cell. In these scenarios, a relatively large energy waste may be generated when the network device periodically transmits the SIB1. In other words, permanent SIB1 transmission wastes energy because it may be unnecessary to continue SIB1 transmission in some cases.

To save power consumed by a network-side device, a network energy saving (network energy saving, NES) technology is introduced. The NES technology can be applied to a plurality of scenarios, so that an operator has an opportunity to reduce the operation costs of any potential deployment. The plurality of scenarios are, for example, an urban micro scenario, a macro scenario, and an indoor hotspot (indoor hotspot, InH) scenario. For the urban micro-scenario and the InH scenario, a quantity of terminal devices that camps on a cell may change significantly over time. In addition, once an overall traffic load is not so high, a network may decide to shut down some cells. Specifically, an access network device may disable SIB1 transmission in a cell, and maintain a basic operation in a neighboring cell.

In an example, the network device may transmit a SIB1 on demand (on demand) to resolve an energy waste problem caused by unnecessary SIB1 transmission. For example, energy saving is implemented by reducing unnecessary SIB1 transmission and related physical random access channel (physical random access channel, PRACH) monitoring, and more opportunities for the network device to be in a sleep mode are provided. However, how to implement on-demand SIB1 transmission to save energy of the network is a technical problem worth studying.

In an example, for the terminal device in the idle/inactive mode, the cell that transmits the on-demand SIB1 (on demand SIB1) is an NES cell. The NES cell does not add SIB1 information when transmitting an SSB. Therefore, the terminal device needs to transmit a SIB1 request to the NES cell to obtain SIB1 information of the NES cell. The SIB1 request is, for example, an uplink wake-up signal (wake up signal, WUS) or on-demand information/signaling. The SIB1 information obtained by the terminal device may come from the NES cell, as shown in FIG. 2.

With reference to FIG. 2, a cell A (cell #A) in service (on) always periodically transmits an SSB (always on). However, the SSB does not contain the SIB1. A communications system of the cell A includes a terminal device 210 and a network device 220. When the terminal device 210 attempts to access the cell A that transmits the SIB1 on demand, the terminal device 210 may transmit an uplink WUS to the network device 220, that is, step S201. If the network device 220 detects the WUS, the network device 220 transmits the SIB1 on demand, that is, step S202.

The foregoing describes the NES technology and the communication process of the NES cell. In this process, how the terminal device transmits the SIB1 request and how the terminal device monitors the on-demand SIB1 transmitted by the network device both are problems that need to be resolved.

For example, the SSB transmitted by the cell A in FIG. 2 may not carry resource configuration information of the SIB1 request.

For another example, after transmitting the SIB1 request based on a power ramp, the terminal device may immediately start decoding indication search space of a physical downlink control channel (physical downlink control channel, PDCCH) related to the SIB1. However, the NES cell may wait for a next SI window to transmit the SIB1. A window length of the SIB1 and a periodicity of the SIB1 are usually relatively long. In this case, the terminal device may perform, in a relatively long time, blind decoding that cannot succeed, until a timer expires, thereby consuming more power.

To resolve the foregoing problem, embodiments of the present application propose a wireless communication method. In this method, the terminal device may determine a transmission manner and/or a configuration parameter of a first request (SIB1 request) based on first configuration information. After the first request is transmitted, the terminal device may further detect and receive a target SIB1 based on a first time window indicated by the first configuration information. It can be learned that transmission of the target SIB1 is triggered by the first request, and monitoring of the terminal device is also performed in the indicated time window. Therefore, power consumption of the terminal device and the network device can be reduced.

For ease of understanding, the following describes in detail the method provided in embodiments of the present application with reference to FIG. 3. FIG. 3 is a schematic flowchart of a wireless communication method according to an embodiment of the present application. The method shown in FIG. 3 includes step S310 to step S330. FIG. 3 is illustrated from a perspective of interaction between a terminal device and a network device.

The terminal device may be any communications device that requests a target SIB1. This is not limited herein. In some embodiments, the terminal device may be a terminal device in an idle state or an inactive state. For example, the terminal device is a UE in an idle/inactive mode. In some embodiments, the terminal device is a communications terminal that supports an NES function.

In some implementations, the terminal device that supports a request-triggered SIB1 is also referred to as a terminal device with an NES capability.

In some implementations, a terminal device that does not support triggering of a SIB1 based on a request of the terminal device is also referred to as a terminal device or a conventional terminal device without an NES capability.

The network device may provide services for a cell in which the terminal device is located. Optionally, the cell in which the terminal device is located may be a cell with which the terminal device currently communicates, may be a cell that the terminal device attempts to access, or may be a cell determined by the terminal device after cell reselection or handover.

In some embodiments, the cell in which the terminal device is located includes a first NES cell. In other words, the cell in which the terminal device is located may be the first NES cell, or may be a plurality of cells including the first NES cell.

A cell corresponding to the network device may be a cell for which the network device provides a service. The cell corresponding to the network device may be the same as the cell in which the terminal device is located, or may be a cell that communicates with the cell in which the terminal device is located.

In some embodiments, the cell corresponding to the network device is the first NES cell. In other words, the network device provides a communication service for the first NES cell. Therefore, the network device may provide a service for the terminal device.

In an example, the first NES cell may be one of a plurality of NES cells. The plurality of NES cells may be indicated by using an NES cell identifier list. If the NES cell identifier list is provided, the same configuration can be used for all these cells.

In some embodiments, the cell corresponding to the network device is a non-NES cell that communicates with the first NES cell, for example, an anchor cell in FIG. 4. The non-NES cell may function as a primary control cell, and is responsible for configuration of first requests of a plurality of NES cells and transmission of the target SIB1. The non-NES cell may keep information exchange with the plurality of NES cells. For example, an SSB transmitted by the non-NES cell carries a SIB1. For brevity, the following uses the non-NES cell to represent a non-NES cell that can communicate with the first NES cell.

In an example, a non-NES cell corresponding to the network device may communicate with the plurality of NES cells including the first NES cell.

In an example, the non-NES cell may also be referred to as an anchor cell or an anchor point cell, that is, the non-NES cell may be an anchor point cell of the plurality of NES cells. The non-NES cell can receive configuration information of the plurality of NES cells.

In an example, the non-NES cell and the NES cell may communicate with each other by using an interface between base stations. For example, the non-NES cell may communicate with the first NES cell by using an Xn interface.

In the foregoing example, when the first request is transmitted based on contention-free random access (contention free random access, CFRA), the non-NES cell may obtain, by using the Xn interface, all preamble indices and/or root sequences that are allocated to the plurality of NES cells based on CFRA. For example, the non-NES cell transmits a signalling request to one or more surrounding NES cells by using the Xn interface, to obtain root sequence information currently used by the non-NES cell. The one or more NES cells may respond with related configuration parameters such as a root sequence to the non-NES cell by using the Xn interface.

In some scenarios, the root sequence of the NES cell may be dynamically adjusted based on a network status or an interference status between other cells. After the root sequence is adjusted, the NES cell can notify the non-NES cell through the Xn interface to ensure that configuration information of the non-NES cell is up to date.

In some scenarios, when the NES cell is reconfigured (for example, load balancing and interference avoidance policy adjustment), new root sequence information is also delivered to the non-NES cell by using the Xn interface.

With reference to FIG. 3, in step S310, the terminal device receives first configuration information. The first configuration information is related to a trigger request of the target SIB1. Therefore, transmission of the target SIB1 helps improve energy utilization and resource utilization.

The target SIB1 is a SIB1 requested from a target cell by the terminal device. Transmission of the target SIB1 is triggered based on a request of the terminal device. Therefore, the target SIB1 is an on-demand SIB1, that is, “OD-SIB1 (on demand SIB1)”.

When the target cell requested by the terminal device is the first NES cell, the target SIB1 is an SIB1 of the first NES cell. Optionally, the target SIB1 received by the terminal device may come from the first NES cell, or may come from the non-NES cell that communicates with the first NES cell.

The request by using which the terminal device triggers the target SIB1 may be the first request. The first request may also be referred to as a SIB1 request. In this embodiment of the present application, the first request is not limited. For example, the first request may be a UL WUS, and is used to wake up the network device on an uplink, so that the network device can transmit the target SIB1 at an appropriate time. For another example, the first request may be “on-demand information or signalling”.

In some embodiments, the first configuration information may include a parameter related to first request configuration. The parameter related to the first request configuration may include a configuration parameter of the first NES cell and/or the non-NES cell. For example, the first NES cell may configure an SSB transmission parameter related to the first request. For example, a non-NES cell may configure an identifier of an applied cell, for example, an NES cell identifier list.

In an example, the parameter related to the first request configuration may come from the first NES cell, or may come from the non-NES cell. For example, the terminal device may receive a configuration parameter transmitted before the first NES cell falls asleep. For another example, the non-NES cell may provide the terminal device with an SSB parameter of an NES cell, for example, ssb PositionsInBurst. In a related specification, the SIB1 indicates ssb PositionsInBurst, and the terminal device may obtain an SSB index based on ssb PositionsInBurst. In the present application, the SSB transmitted by the NES cell does not carry the SIB1. Therefore, the non-NES cell may indicate an SSB number/index, so that the terminal device determines mapping between an SSB of the NES cell and a transmission occasion of the first request. Otherwise, the terminal device cannot select an appropriate first request transmission occasion corresponding to the best SSB index of the terminal device.

In the foregoing example, when the terminal device transmits the first request based on a random access process, the transmission occasion of the first request may share a random access channel occasion (random access channel occasion, RO).

In an example, the first configuration information may include resource configuration information of the first request. For example, the first request may be transmitted by using a PRACH resource, to trigger the first NES cell to transmit the target SIB1. FIG. 2 is used as an example. If an SSB transmitted by a cell A carries a WUS/on demand information or resource configuration information of signaling, when the terminal device 210 attempts to access the cell A that transmits a SIB1 on demand, the terminal device may transmit a UL WUS to the cell #A based on the configuration information. For example, the terminal device 210 may trigger, by using the first request transmitted based on a random access channel (random access channel, RACH) or a separate signal or sequence, the cell A to transmit the target SIB1. If the cell A detects the first request, the cell transmits the on-demand SIB1.

In an example, the first configuration information may indicate a first preamble related to the first request. Description is provided below with reference to step S320.

In some embodiments, the first configuration information may indicate one or more of the following configuration information: transmission of the first request; reception of the target SIB1; or reception of a response related to the first request. When the terminal device transmits the first request based on the random access process, the response related to the first request may also be a random access response (random access response, RAR).

In an example, for transmission of the first request, the first configuration information may indicate that the first request is transmitted based on the random access process. For example, the first configuration information may include a resource required for successfully completing the first request.

In the foregoing example, when the first request is transmitted based on CFRA, the first configuration information may specify a related preamble (preamble) index and its root sequence, and may further provide a parameter required for UL power control. For example, the non-NES cell may add information of the preamble index and/or the root sequence to the first configuration information. After obtaining the first configuration information (for example, NES UE UL WUS configuration information) from the non-NES cell, the terminal device may initiate the random access process based on CFRA.

In an example, for reception of the target SIB1, the first configuration information may include a resource that is used to detect a PDCCH or a physical downlink shared channel (physical downlink shared channel, PDSCH) of the SIB1 (or referred to as SIB1 capture), so that the terminal device can detect and receive the target SIB1 in time.

In an example, for reception of the target SIB1, the first configuration information may indicate a transmission resource of the target SIB1. The transmission resource of the target SIB1 may include a first time window for receiving the target SIB1, or may include a frequency resource. Description is provided below with reference to step S330.

In an example, the first configuration information may further include a resource for receiving the response related to the first request. The RAR is used as an example. The first configuration information may include a resource used to receive the RAR. The RAR may be used as an explicit trigger for the terminal device to start monitoring a resource used to receive the target SIB1. For example, when transmitting the first request based on the power ramp parameter, the terminal device does not start monitoring the SIB1 until receiving the RAR or PreambleTransMax. If the RAR is not set, the terminal device may consume more power to receive the target SIB1. This is because a system information window is longer than an RAR response time.

In an implementation, when the first request is a WUS, the first configuration information may include one or more of the following parameters: NES-CellId; SIB1-RequestConfig; frequencyInfoUL; pdcch-ConfigSIB1; or pdcch-ConfigOD-SIB1-RAR. The parameter NES-CellId is used to determine a specific cell supported by related configuration (To which cell does the config applies). The parameter SIB1-RequestConfig and the parameter frequencyInfoUL are used for WUS transmission (transmission). The parameter pdcch-ConfigSIB1 is used for reception (reception) of the target SIB1. The parameter pdcch-ConfigOD-SIB1-RAR is used for RAR reception. Details are shown in Table 1.

TABLE 1

| Purpose | | | |
|---|---|---|---|
| (purpose) | Parameters (parameters) | | |
| Configuration- | NES-CellId | PhysCellId | |
| supported cell | | ARFCN-ValueNR | |
| WUS | SIB1- | ss-PBCH-BlockPower | |
| transmission | RequestConfig | rach- | Prach-ConfigurationIndex |
| | | OccasionsSIB 1 | msg1-FDM |
| | | | msg1-FrequencyStart |
| | | | zeroCorrelationZoneConfig |
| | | | preambleReceivedTargetPower |
| | | | preambleTransMax |
| | | | powerRampingStep |
| | | | ra-ResponseWindow |
| | | | ssb-perRACH-Occasion |
| | | sib1-RequestPeriod | |
| | | sib1- | ra-PreambleStartIndex |
| | | RequestResource | ra-AssociationPeriodIndex |
| | | | ra-ssb-OccasionMaskIndex |

| | | |
|---|---|---|
| | | rsrp-ThresholdSSB |
| | | prach-RootSequenceIndex |
| | | msg1-SubcarrierSpacing |
| | | restrictedSetConfig |
| | | tdd-UL-DL-ConfigurationCommon |
| | frequencyInfoUL | frequencyBandList |
| | | absoluteFrequencyPointA |
| | | offsetToCarrier |
| | | p-Max |
| | | frequencyShift7p5khz |
| SIB 1 reception | pdcch- | ssb-SubcarrierOffset |
| | ConfigSIB1 | controlResourceSetZero |
| | | searchSpaceZero |
| RAR reception | pdcch-ConfigOD- | controlResourceSet |
| | SIB1-RAR | monitoringSlotPeriodicityAndOffset |
| | | duration |
| | | monitoringSymbolsWithinSlot |
| | | aggregationLevels |

It may be learned from Table 1 that the first configuration information may include transmission parameters for requesting the target SIB1, and may further include transmission parameters of the target SIB1. For example, the first configuration information may include request parameters of the target SIB1 that are transmitted by the non-NES cell and the transmission parameters of the target SIB1.

The terminal device may receive the first configuration information in a plurality of manners. In an example, the terminal device may directly receive the first configuration information transmitted by the network device. For example, when the trigger request of the target SIB1 is an uplink WUS, the terminal device may receive uplink WUS configuration (UL WUS Config) transmitted by the network device. In an example, the terminal device may determine the first configuration information based on higher layer signalling.

For example, when the network device corresponds to a non-NES cell, the non-NES cell may transmit the first configuration information to terminal devices in a plurality of NES cells. The plurality of NES cells include the first NES cell.

Step S320: The terminal device transmits the first request to the network device, where the first request is used to request the target SIB1. The network device may receive the first request transmitted by the terminal device, and trigger transmission of the target SIB1. For example, when the network device corresponds to a non-NES cell, the terminal device may transmit an uplink WUS to the non-NES cell.

The target SIB1 corresponds to the first NES cell. In other words, the target SIB1 is a SIB1 triggered by the first request corresponding to the first NES cell, that is, the target SIB1 is a SIB1 of the first NES cell.

When transmitting the first request based on the random access process, the terminal device may transmit the first request based on a preamble. For example, the first request may include a first preamble, and the first preamble is used by the terminal device to request the target SIB1. For another example, the first request may correspond to the first preamble, or the first request is related to the first preamble.

The first preamble related to the first request may reuse a preamble in a related communications system. A preamble of NR random access is used as an example. The preambles may be divided into three parts: contention-based random access, contention-free random access (also referred to as non-contention random access), and another part. For CFRA, a higher-layer parameter indicates a specific to-be-used preamble, to avoid a case in which interference is caused because different terminal devices select the same preamble. In CFRA, a network (by using a radio resource control (radio resource control, RRC) layer) may directly specify a preamble for the terminal device. This process is implemented through higher layer signalling, for example, through an RRC Connection Reconfiguration message.

It can be learned from the foregoing description that the terminal device may transmit the first request based on CFRA, to ensure random access without contention and conflict. Transmitting the first request by using only a preamble of CFRA may meet a requirement, because all terminal devices request the same message, that is, the target SIB1. In addition, a manner in which the network device meets the first request based on the target SIB1 transmitted through broadcasting is also relatively effective. No dedicated transmission is needed, to reduce overheads. In comparison with contention-based random access, CFRA can save a quantity of parameters required for configuration of the first request.

In this embodiment of the present application, a sequence of the preamble is not limited. For example, the preamble may be generated based on a Zadoff-Chu sequence, and has a good correlation characteristic in time and frequency.

The first configuration information may be used to indicate the first preamble. When the first configuration information comes from the non-NES cell, the non-NES cell may indicate the first preamble based on the preamble transmitted by the first NES cell. When the first configuration information comes from the first NES cell, the first NES cell may directly allocate the first preamble to the terminal device. In other words, the terminal device may obtain the first preamble and an index of the first preamble from the non-NES cell, or may obtain the first preamble and an index of the first preamble from the first NES cell.

Optionally, after obtaining the first configuration information, the terminal device may determine the first preamble based on the first configuration information.

Optionally, when obtaining the first configuration information from the non-NES cell or the first NES cell, the terminal device may obtain a preamble index when transmitting the first request based on CFRA.

In some embodiments, when a plurality of terminal devices including the terminal device transmit a plurality of first requests, the plurality of first requests may be transmitted based on the same preamble. In other words, the non-NES cell or the first NES cell may specify the same preamble index and the same root sequence for each terminal device. For example, when the first request transmitted by the terminal device includes the first preamble, the first preamble may be used by the plurality of terminal devices transmitting the first requests.

In some embodiments, the non-NES cell or the first NES cell may specify a unique preamble index and a unique root sequence for each terminal device. In CFRA, one unique preamble index may be allocated to each terminal device. The index is usually selected from an available preamble set. For example, a base station (gNB) may pre-allocate one or more preamble indices to each terminal device according to a network plan or a specific requirement of the terminal device.

In an example, when the first request includes the first preamble, the first preamble may be one preamble in a first preamble group. The preamble in the first preamble group may be used by the plurality of terminal devices transmitting the first requests. For example, all preambles in the first preamble group may be dedicated preambles of SIB1 requests.

In an example, the first preamble group includes a plurality of preambles, and the plurality of preambles are in one-to-one correspondence with the plurality of terminal devices.

In the foregoing example, the first preamble group may be one or more of the following: the first preamble group is one of at least two preamble groups used for CFRA; or the preamble in the first preamble group is a preamble reserved for the network device.

For example, preambles used for CFRA may be divided into at least two preamble groups. The at least two preamble groups may include a first preamble group and a second preamble group. The second preamble group is used in the random access process.

It can be learned from the foregoing description that the first NES cell keeps information exchange with the non-NES cell. The first NES cell may divide contention-free access preambles into two groups: a group A (Group A) and a group B (Group B). The group A is used by users of this cell, for example, a preamble allocated during handover. The group B is used by the terminal device initiating the first request. The first NES cell transmits a preamble in the group B and/or a preamble index to the non-NES cell, so that the non-NES cell allocates the preamble index and/or the preamble to the terminal device. When each terminal device that is assigned with a CFRA preamble initiates a first request in the NES cell, a preamble specified by a network is used, to ensure contention-free access.

For example, the first NES cell further allocates a reserved preamble to the terminal device transmitting the first request. The reserved preamble is, for example, a preamble in the another part of the NR preambles described above.

For example, when the first preamble group includes a preamble group used for CFRA (for example, the group B) and a reserved preamble, it may be determined, based on a second condition, whether to use a preamble in the group B or a reserved preamble.

In an implementation, the second condition is related to location information of the terminal device. In other words, when the first preamble group includes a preamble group used for CFRA and a reserved preamble, the first preamble is determined based on location information of the terminal device. For example, when the terminal device is on an edge of the non-NES cell/the first NES cell, the non-NES cell/the first NES cell may allocate the preamble in the group B to the terminal device, and allocate the reserved preamble to a terminal device at another location; or the reverse is also applicable.

Still with reference to FIG. 3, in step S330, the terminal device receives the target SIB1 transmitted by the network device. Correspondingly, the network device transmits the target SIB1. For example, when the network device corresponds to the non-NES cell, if the non-NES cell receives the first request, the network device may transmit the target SIB1 to the terminal device in the first NES cell.

In some embodiments, transmission of the target SIB1 is determined based on a first condition. In other words, even if the network device receives the first request, transmission of the target SIB1 also requires another trigger condition, to reduce power consumption of the terminal device and the network device. Power consumption costs of the terminal device and the network device are proportional to a rate of a trigger event for obtaining the target SIB1. For a high-mobility terminal device, a cell reselection event may occur frequently, and an excessive request for the target SIB1 is also triggered. This causes frequent transmission of the target SIB1. This is not ideal for reducing power consumption for both the terminal device and the network, as well as the interference within the network. When determining, based on the first condition, whether to transmit the target SIB1, transmission frequency of the target SIB1 may be avoided/minimized based on an effective mechanism, thereby reducing power consumption.

In some embodiments, the first condition may include one or more of the following: whether a cell corresponding to the network device receives a first-type trigger event; a quantity of terminal devices transmitting the first request in a cell corresponding to the network device; or a measurement result of the terminal device.

In an example, the first-type trigger event may be an event that is used to trigger transmission of the target SIB1, other than the trigger by using the first request. For the first-type trigger event, the first NES cell may know occurrence of the trigger event through presetting, to transmit the target SIB1 to the terminal device in a case that there is no first request. For example, the first-type trigger event may include an event that can trigger transmission of the SIB1, such as reception of an indication that system information has changed, reception of a notification of a public warning system (public warning system, PWS), and reconfiguration after synchronization is completed. For example, the first-type trigger event may further include events such as cell reselection and cell handover initiated by a conventional terminal device. For example, the first-type trigger event may further include an event, for example, that the terminal device returns from the outside of coverage, that the terminal device enters the network from another radio access technology (radio access technology, RAT), that the terminal device receives a request (for example, a positioning request) from an upper layer, that the terminal device does not store a SIB or that a valid version of a SIB expires or that a valid version of a SIB is requested, and that the terminal device performs satellite switching with resynchronization.

In this embodiment of the present application, a conventional terminal device and a terminal device that supports NES may have different operations for the first-type trigger event. Once the terminal device that supports NES camps on the first NES cell, after receiving an SI-changed indication, the terminal device may also trigger transmission of the first request. The first NES cell/the non-NES cell may transmit the target SIB1 in a next SI modification periodicity. In other words, the terminal device that camps on the first NES cell transmits the first request, to avoid frequently triggering transmission of the target SIB1 to a terminal device that moves at a high speed. However, the terminal device that supports NES may frequently trigger transmission of the first request in a high-speed moving environment. If the terminal device has not received the target SIB1 after N (N is an integer) transmissions, or the terminal device has not received the target SIB1 within a specific time T, the terminal device may consider that the last received SIB1 does not change, and complete a subsequent operation based on the stored last SIB1.

In an example, the first condition may be related to a quantity of terminal devices that transmit the first request in the cell corresponding to the network device. Alternatively, the quantity of terminal devices that transmit the first request may be replaced with a quantity of terminal devices that trigger transmission of the target SIB1.

In the foregoing example, the quantity of terminal devices may be further used to determine a transmission manner of the target SIB1. When the quantity of terminal devices is greater than a first threshold, the target SIB1 may be transmitted through broadcasting. When the quantity of terminal devices is less than or equal to a first threshold, the target SIB1 is transmitted by using downlink control information (downlink control information, DCI). The reverse is also applicable.

In an implementation, the first NES cell/the non-NES cell may count, in a small counting time [Tₘᵢₙ, Tₘₐₓ], a quantity of users that transmit the first request or a quantity of users in trigger events that trigger transmission of the SIB1. If the counted quantity is greater than a specified value, after the counting time, the first NES cell/the non-NES cell may immediately transmit the target SIB1 by using a broadcast message instead of DCI. If the counted quantity is less than a specified value, after the counting time, the first NES cell/the non-NES cell may transmit the target SIB1 by using DCI instead of a broadcast message.

For ease of understanding, the following uses FIG. 4 as an example for description. A communication method shown in FIG. 4 is performed by a network device.

With reference to FIG. 4, in step S410, the network device determines whether a quantity of terminal devices transmitting a first request is greater than a first threshold. If the quantity of terminal devices transmitting the first request is greater than the first threshold, step S420 is performed. If the quantity of terminal devices transmitting the first request is not greater than the first threshold, step S430 is performed.

In step S420, the network device transmits a target SIB1 through broadcasting.

In step S430, the network device transmits the target SIB1 by using downlink control information.

It should be understood that determining a transmission manner of the target SIB1 based on the quantity of terminal devices and a value relationship of the first threshold in FIG. 4 is merely an example. In some scenarios, after determining is performed in step S410, step S430 is performed if the quantity of terminal devices transmitting the first request is greater than the first threshold, or step S420 is performed if the quantity of terminal devices transmitting the first request is not greater than the first threshold.

In an implementation, when the quantity of terminal devices is greater than the first threshold, the target SIB1 may be transmitted by using the DCI; or when the quantity of terminal devices is less than or equal to the first threshold, the target SIB1 is transmitted by using the DCI. In a frequency range (frequency range, FR) 2 scenario, transmission of a broadcast message needs to be transmitted through scanning each beam, and consumes more power in comparison with DCI transmission.

In an example, a measurement result of the terminal device includes a reference signal received power (reference signal received power, RSRP) value obtained through measurement by the terminal device. The RSRP value may be a result of measuring a received SSB. In an implementation, when the RSRP value obtained through measuring the SSB is greater than a threshold RSRP_{target}, the terminal device can trigger transmission of the target SIB1.

In some embodiments, to receive the target SIB1, the terminal device needs to be synchronized with a cell transmitting the target SIB1. For example, when a non-NES cell is a first NES cell and transmits the target SIB1, the terminal device needs to be synchronized with the non-NES cell in time and frequency.

In some embodiments, to receive the target SIB1, the terminal device further needs to determine other information of the cell transmitting the target SIB1. For example, when a non-NES cell is a first NES cell and transmits the target SIB1, the terminal device needs to detect a physical layer cell identity (identity, ID) of the non-NES cell.

It can be learned from the foregoing description that first configuration information may indicate a transmission resource of the target SIB1. For example, the transmission resource of the target SIB1 may include a first time window in which the terminal device receives the target SIB1. For example, the transmission resource of the target SIB1 may include a frequency resource corresponding to the first NES cell. For example, the transmission resource of the target SIB1 may be a physical resource block (physical resource block, PRB).

In some embodiments, the first time window may include a time domain location at which the network device transmits the target SIB1 or the terminal device receives the target SIB1. The first configuration information is further used to indicate the first time window. Optionally, the first configuration information may indicate a location of the target SIB1 in the first time window. Optionally, the first configuration information may indicate how the terminal device determines a location of the target SIB1 in the first time window. For example, the first configuration information may indicate that the location of the target SIB1 in the first time window is determined based on the ID of the first NES cell.

In an example, the first time window may be associated with the foregoing RAR time window. For example, when the first request is transmitted based on a random access process, the first time window may be a time window used to detect a random access response.

In an example, the first time window may be associated with a send window of an SI. When the network device corresponds to a non-NES cell, because the non-NES cell may transmit target SIB1s of a plurality of NES cells, a related SI collection process may be used for transmission. In other words, the non-NES cell may transmit the target SIB1s to terminal devices in different NES cells in an SI transmission manner. For example, the first time window is an SI window, and the target SIB1 is transmitted by using the SI window. The following is described by using an example with reference to a manner of determining the first time window.

In some embodiments, when the network device of the non-NES cell provides a service for the plurality of NES cells including the first NES cell, a plurality of SIB1s (that is, a plurality of target SIB1s or on-demand SIB1s) of the plurality of NES cells are respectively transmitted on different frequency resources.

In an example, the frequency resource may be a bandwidth part (bandwidth part, BWP), a frequency band, a frequency range, or a carrier. For example, different frequency resources corresponding to the plurality of NES cells are different BWPs.

In an example, the BWP is divided in non-NES cells, and different target SIB1 resources are allocated to different NES cells, thereby optimizing resource utilization and reducing interference. The BWP is usually a segment of consecutive spectrum resources, and can be independently configured and managed in NR. The non-NES cell can be configured with a plurality of BWPs. Each BWP can support different bandwidth and parameter configuration.

In an implementation, the non-NES cell may perform division to obtain a plurality of BWPs based on a spectrum resource of the non-NES cell and a quantity of NES cells served by the non-NES cell. Different BWPs are allocated to different NES cells.

In an implementation, a specific target SIB1 resource is allocated to each BWP in the BWPs obtained through division. For example, the first NES cell corresponds to a first BWP, and the first BWP includes a dedicated resource of the target SIB1. Each BWP corresponding to each NES cell may include a dedicated resource corresponding to a SIB1. A terminal device in each NES cell may receive a target SIB1 in the BWP corresponding to the cell. This configuration can avoid SIB1 information interference generated between a plurality of different NES cells, and improve resource utilization efficiency.

In an implementation, the non-NES cell may transmit allocation information of frequency resources to the terminal devices in the plurality of NES cells. For example, the non-NES cell may broadcast, to a terminal device in each NES cell by using a SIB or dedicated signalling, configuration information of a BWP and a target SIB1 corresponding to each NES. In this way, the terminal device knows a specific BWP and a specific frequency band on which the target SIB1 is received. The terminal device in each NES cell receives, based on received configuration information, the target SIB1 on the BWP allocated to the NES cell in which the terminal device in each NES cell is located.

In an implementation, the non-NES cell may dynamically adjust BWP bandwidth and target SIB1 resource allocation of each NES cell based on real-time network loads and cell requirements of the plurality of NES cells. For example, when a load of a specific NES cell increases, bandwidth of a BWP of the NES cell may be expanded, or more target SIB1 resources may be reallocated.

In an implementation, in a case of a low load, different NES cells may share some BWP resources. For example, the plurality of NES cells may multiplex a first request resource and/or a target SIB1 resource in a time division manner or a frequency hopping manner, to improve spectrum utilization.

In some embodiments, the non-NES cell may allocate different PRBs or the same PRB to different NES cells. One PRB is usually formed by a combination of one subcarrier and one slot, and is a minimum allocation unit of a time-frequency resource. When different PRBs are allocated, interference between SIB1 information can be avoided. When the same PRB is allocated, spectrum utilization can be improved. Further, multiplexing and hopping technologies of PRBs may be used to improve spectrum utilization. To be specific, based on hopping or multiplexing of the same PRB, it can be ensured that a PRB used for transmitting target SIB1s of a plurality of NES cells does not in conflict, thereby avoiding signal conflicts between different cells.

In an example, the same PRB resource allocated to different NES cells may be referred to as a first resource. The non-NES cell may allocate the same PRB resource to an NES cell in an NES cell group (or referred to as an NES cell set). For example, when the first NES cell is one cell in the first NES cell group, a plurality of SIB Is corresponding to a plurality of NES cells in the first NES cell group may be transmitted through multiplexing the first resource.

In the foregoing example, by using the frequency hopping technology, different NES cells may use the same PRB resource (the first resource) at different frequencies, and frequency hopping may occur in time. In this way, even if two NES cells use the same PRB in a specific slot, the two NES cells do not interfere with each other because of different frequencies. Frequency hopping may be performed in a preset mode (such as a pseudo random sequence). The PRB of each cell hops to different frequency locations in different time periods, so that long-term frequency interference can be reduced.

In the foregoing example, in a cell having a MIMO antenna system, a PRB may be multiplexed in different spatial directions by using a beamforming technology. In other words, the first resource may be multiplexed based on a spatial direction. For example, two NES cells may separately use the same PRB in different antenna beam directions without interfering with each other.

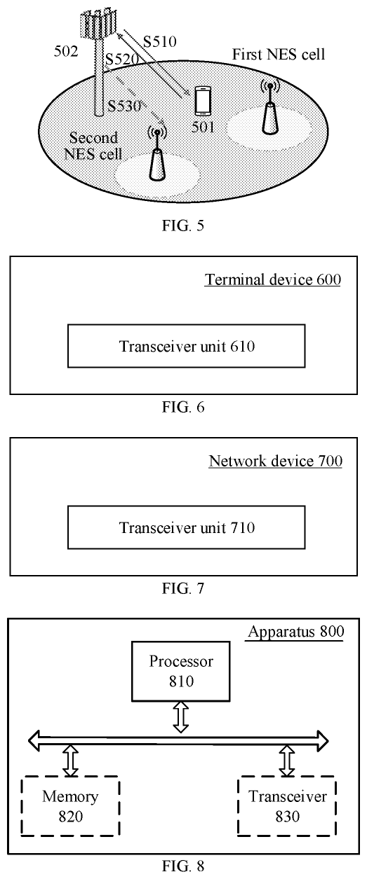

With reference to FIG. 3 and FIG. 4, the foregoing describes a method embodiment in which the terminal device transmits the first request and receives the target SIB1 based on an indication of the first configuration information. For ease of understanding, a system structure and a procedure are described below with reference to FIG. 5 by using an example in which the non-NES cell transmits the target SIB1. In FIG. 5, a cell served by a network device 502 is an anchor cell, that is, a non-NES cell. Within a coverage of the anchor cell, a terminal device 501 and two NES cells: a first NES cell and a second NES cell are shown as an example.

With reference to FIG. 5, in step S510, the network device 502 transmits UE UL WUS configuration information of the first NES cell and the second NES cell to the terminal device 501.

In step S520, the terminal device 501 transmits an uplink WUS (a first request) to the network device 502 to request a target SIB1 of the first NES cell or the second NES cell.

In step S530, after receiving a request signal from the terminal device, the network device 502 transmits the target SIB1 to the terminal device that initiates the request in the first NES cell or the second NES cell.

In the methods shown in FIG. 3 to FIG. 5, first configuration information may indicate a transmission resource of the target SIB1. The transmission resource of the target SIB1 may include a first time window in which the terminal device receives the target SIB1. The first time window may be related to an SI window. When a non-NES cell transmits a target SIB1 of a plurality of NES cells based on the same SI window, there may be a large quantity of SIB1 messages. How to perform configuration by using a plurality of SIB1s to reduce a conflict is a problem that needs to be considered. In addition, an excessively large quantity of SIB1 messages may further cause an excessively long SI window periodicity or cause interference. If the SI window periodicity is excessively long, a delay of transmitting the SIB1 by the network device to the terminal device in the NES cell may be increased.

On this basis, an embodiment of the present application further provides a method for indicating the transmission resource of the target SIB1. The method is determining a start instant or an offset of SI of each cell in an SI window based on a cell ID according to an SI window offset policy based on a cell ID. In this method, the network device may evenly distribute SI broadcasting slots of a plurality of NES cells, to avoid conflicts and optimize resource utilization.

In some embodiments, a location of the target SIB1 in the first time window is determined based on an ID of the first NES cell. The ID of the first NES cell may be a physical cell ID (physical cell identity, PCI).

For example, the ID of the first NES cell is used to determine a first offset of the target SIB1 in the first time window. In other words, the ID of the first NES cell may be used to determine a start instant of the target SIB1 in the SI window. If one SI window includes 10 subframes, and the first offset of the first NES cell is 3, target SIB1 information of the first NES cell starts to be broadcast in the 3^{rd} subframe in the SI window. Different offsets are generated based on different cell IDs, to ensure that terminal devices in a plurality of NES cells read target SIB1s of their cells at different instants, thereby reducing signal conflicts and interference.

In an example, when the first time window is used to transmit a plurality of SIB1s including the target SIB1, and the first offset SI_{offset} satisfies:

$${SI}_{offset} = ( {cell}_{ID} \times k ) mod T .$$

Herein, cell_{ID} is the ID of the first NES cell, k is a spacing factor related to a spacing is of plurality of SIB1s in first time window, and T is a length of the first time window.

Optionally, cell_{ID} may be a PCI of the first NES cell.

Optionally, k may be a first spacing factor corresponding to the target SIB1, and k may be a constant factor that is used to adjust a span of an offset to ensure sufficient separation of different NES cells within the SI window. Distribution density of SI information and a spacing between different NES cells in the SI window can be controlled by adjusting a k value, to adapt to requirements of different networks.

Optionally, T is a total length of the SI window, and T may represent a quantity of slots or a quantity of subframes included in the first time window or included in the SI window.

In some embodiments, the target SIB1 corresponds to the first NES cell, and the first NES cell is one of a plurality of NES cells served by the network device. When the network device corresponds to a non-NES cell that communicates with the plurality of NES cells, the location of the target SIB1 in the first time window and/or the first spacing factor corresponding to the target SIB1 may be further determined based on a load of the non-NES cell and/or a load of the first NES cell.

In an example, when the load of the first NES cell is relatively high, distribution of target SIB1s in the first time window may be more intensive. For example, when the load is relatively high, target SIB1s are distributed more intensively in time domain or frequency domain by increasing an offset parameter value/a spacing factor in time domain or frequency domain. This means that the SI information can be transmitted more frequently. In a case that the load is relatively low, the offset parameter value/spacing factor may be reduced, to reduce broadcasting frequency of the SI information, thereby saving resources. In other words, the spacing factor is adjusted in real time based on a load status of the first NES cell.

In an example, the load of the non-NES cell may include a load status of each NES cell within coverage of the non-NES cell. The non-NES cell can continuously monitor the load status of the non-NES cell and a network load status of each NES cell within the coverage of the non-NES cell. Based on a real-time network load, the non-NES cell can dynamically adjust the k value in the foregoing formula, or directly adjust an offset of a specific NES cell. For example, in a high-load NES cell, an offset of the SI window may be slightly adjusted, to ensure that the SI information can be transmitted more frequently.

In an example, the load of the non-NES cell is related to one or more of the following information: a quantity of NES cells that communicate with the non-NES cell; a quantity of terminal devices that transmit a SIB1 request; transmission frequency of a SIB1 request; or an occupation rate of a physical resource block (PRB) of an uplink resource.

In an example, the load of the first NES cell is related to one or more of the following information: a quantity of terminal devices that transmit a SIB1 request; transmission frequency of a SIB1 request; or an occupation rate of a PRB of an uplink resource. In other words, the network load may be measured by using the following indicators: a quantity of terminals that transmit a first request in each NES cell within a period of time, and frequency of the request; or usage of an uplink frequency resource that is measured by using a PRB occupation rate.

In an implementation, the non-NES cell may set one or more load thresholds for each NES cell within the coverage of the non-NES cell. For example, when the PRB occupation rate exceeds 80% or the quantity of terminal device connections reaches a specific quantity, adjustment for the offset of the SI window is triggered.

In an implementation, the first spacing factor may be adjusted based on the load of the first NES cell. The first spacing factor may be adjusted according to a linear or nonlinear formula. For example, a second spacing factor k_{adjust} obtained after the first spacing factor is adjusted satisfy:

$${k}_{adjust} = {k}_{initial} * ( 1 + \frac{Q - {Q}_{adjust}}{{Q}_{max} - Q} ) .$$

Herein, kᵢₙᵢₜᵢₐₗ is an initial spacing factor, Q is a real-time load value, Q_{adjust} is an intermediate load value used to adjust the spacing factor, and Qₘₐₓ is a maximum load value of the first NES cell.

In an example, the real-time adjusted second spacing factor is not necessarily used to determine a new offset. In other words, it may be determined based on a specific condition whether the second spacing factor is used to determine the new offset, to reduce a calculation amount.

In an implementation, when a difference between the second spacing factor and the first spacing factor is greater than or equal to a second threshold, the second spacing factor is used to determine the location of the target SIB1 in the first time window; or when a difference between the second spacing factor and the first spacing factor is less than a second threshold, the first spacing factor is used to determine the location of the target SIB1 in the first time window.

In an implementation, a second offset determined based on the second spacing factor is as follows:

$${SI}_{offset} = ( {cell}_{ID} \times {k}_{adjust} ) mod T .$$

In an implementation, after a new offset is calculated, a system may immediately update the SI window, so that the SI information can be broadcast more frequently in a high-load case. It should be understood that after the offset is adjusted, the non-NES cell should further continuously monitor adjustment effect, including transmission efficiency of the SI information and a change of the network load.

In an example, the first spacing factor may further be adjusted based on one or more of the following information: a priority of the first NES cell; a location of the first NES cell in the coverage of the non-NES cell; or a level of an ID of the first NES cell.

In an implementation, the non-NES cell allocates different priorities to the plurality of NES cells based on importance of the plurality of NES cells, or performs a differentiated spacing factor adjustment policy on NES cells with different priorities. For example, a cell with a high priority may be allocated with more slots in the SI window, so that SI information of these cells can be broadcast more frequently. An adjustment amplitude of the SI window may be larger.

In an implementation, the non-NES cell allocates different priorities to the plurality of NES cells based on coverage of the plurality of NES cells, or performs a differentiated spacing factor adjustment policy on NES cells in different areas. For example, an NES cell at a core location may be set with a relatively small threshold and a relatively large adjustment amplitude, while an NES cell at an edge location is relatively conservative.

In an implementation, for a network with a larger scale, IDs of NES cells may be considered to be divided into different levels. Different offset calculation formulas, or spacing factor adjustment policies, or SI window lengths are used for cells at different levels. For example, an NES cell at a level 1 uses a relatively short SI window, and an NES cell at a level 2 uses a relatively long SI window. By using this multi-level offset policy, more uniform SI information distribution can be implemented in the network.

The foregoing describes the method embodiments of the present application in detail with reference to FIG. 1 to FIG. 5. The following describes in detail the apparatus embodiments of the present application with reference to FIG. 6 to FIG. 8. It should be understood that the description of the apparatus embodiments corresponds to the description of the method embodiments. Therefore, for parts that are not described in detail, reference may be made to the foregoing method embodiments.

FIG. 6 is a schematic block diagram of a terminal device according to an embodiment of the present application. The terminal device 600 may be any one of the terminal devices described above. The terminal device 600 shown in FIG. 6 may include a transceiver unit 610.

The transceiver unit 610 may be configured to receive first configuration information, where the first configuration information is related to a trigger request of a target SIB1. The transceiver unit 610 is further configured to transmit a first request to a network device, where the first request is used to request the target SIB1. The transceiver unit 610 is further configured to receive the target SIB1 transmitted by the network device. The first configuration information is used to indicate a first preamble related to the first request and/or a transmission resource of the target SIB1.

Optionally, the transceiver unit 610 is further configured to transmit the first request based on CFRA.

Optionally, the first request includes the first preamble, and the first preamble is used by a plurality of terminal devices transmitting the first request.

Optionally, the first request includes the first preamble, the first preamble is one preamble in a first preamble group, and a preamble in the first preamble group is used by a plurality of terminal devices transmitting the first request.

Optionally, the first preamble group is one or more of the following: the first preamble group is one of at least two preamble groups used for CFRA, the at least two preamble groups further include a second preamble group, and the second preamble group is used for a random access process; or the preamble in the first preamble group is a preamble reserved for the network device.

Optionally, when the first preamble group includes a preamble group used for CFRA and a reserved preamble, the first preamble is determined based on location information of the terminal device.

Optionally, transmission of the target SIB1 is determined according to a first condition, and the first condition includes one or more of the following: whether a cell corresponding to the network device receives a first-type trigger event; a quantity of terminal devices transmitting the first request in a cell corresponding to the network device; or a measurement result of the terminal device.

Optionally, when the quantity of terminal devices is greater than a first threshold, the target SIB1 is transmitted through broadcasting; or when the quantity of terminal devices is less than or equal to a first threshold, the target SIB1 is transmitted by using downlink control information.

Optionally, the first configuration information includes one or more of the following: NES-CellId; SIB1-RequestConfig; frequencyInfoUL; pdcch-ConfigSIB1; or pdcch-ConfigOD-SIB1-RAR.

Optionally, the transmission resource of the target SIB1 includes a first time window in which the terminal device receives the target SIB1, and the first configuration information is further used to indicate a location of the target SIB1 in the first time window, or a location of the target SIB1 in the first time window is determined based on an ID of a cell corresponding to the target SIB1.

Optionally, the target SIB1 corresponds to a first NES cell, and an ID of the first NES cell is used to determine a first offset of the target SIB1 in the first time window.

Optionally, the first time window is used to transmit a plurality of SIB1s including the target SIB1, and the first offset SI_{offset} satisfies:

$${SI}_{offset} = ( {cell}_{ID} \times k ) mod T .$$

Herein, cell_{ID} is the ID of the first NES cell, k is a spacing factor related to a spacing of plurality of SIB1s in first time window, and T is a length of the first time window.

Optionally, the target SIB1 corresponds to a first NES cell, the first NES cell is one of a plurality of NES cells served by the network device, the network device corresponds to a non-NES cell that communicates with the plurality of NES cells, and at least one of the location of the target SIB1 in the first time window or a first spacing factor corresponding to the target SIB1 is determined based on a load of the first NES cell.

Optionally, the first spacing factor is adjusted based on the load of the first NES cell, and a second spacing factor k_{adjust} obtained after the first spacing factor is adjusted satisfy:

$${k}_{adjust} = {k}_{initial} * ( 1 + \frac{Q - {Q}_{adjust}}{{Q}_{max} - Q} ) .$$

Herein, kᵢₙᵢₜᵢₐₗ is an initial spacing factor, Q is a real-time load value, Q_{adjust} is an intermediate load value used to adjust the spacing factor, and Qₘₐₓ is a maximum load value of first NES cell.

Optionally, when a difference between the second spacing factor and the first spacing factor is greater than or equal to a second threshold, the second spacing factor is used to determine the location of the target SIB1 in the first time window; or when a difference between the second spacing factor and the first spacing factor is less than a second threshold, the first spacing factor is used to determine the location of the target SIB1 in the first time window.

Optionally, the first spacing factor may be further adjusted based on one or more of the following information: a priority of the first NES cell; a location of the first NES cell in coverage of the non-NES cell; or a level of an ID of the first NES cell.

Optionally, the target SIB1 corresponds to a first NES cell, a transmission resource corresponding to the target SIB1 includes a frequency resource corresponding to the first NES cell, the first NES cell is one of a plurality of NES cells served by the network device, and a plurality of SIB1s of the plurality of NES cells are respectively transmitted on different frequency resources.

Optionally, the different frequency resources are different BWPs, the first NES cell corresponds to a first BWP, and the first BWP includes a dedicated resource of the target SIB1.

Optionally, the target SIB1 corresponds to a first NES cell, the first NES cell is one cell in a first NES cell group, and a plurality of SIB1s corresponding to a plurality of NES cells in the first NES cell group are transmitted through multiplexing a first resource.

Optionally, the target SIB1 corresponds to a first NES cell, and the network device corresponds to the first NES cell, or the network device corresponds to a non-NES cell that communicates with the first NES cell.

FIG. 7 is a schematic block diagram of a network device according to an embodiment of the present application. The network device 700 may be any one of the foregoing network devices. The network device 700 shown in FIG. 7 includes a transceiver unit 710.

The transceiver unit 710 may be configured to transmit first configuration information, where the first configuration information is related to a trigger request of a target SIB1. The transceiver unit 710 is further configured to receive a first request transmitted by a terminal device, where the first request is used to request the target SIB1. The transceiver unit 710 is further configured to transmit the target SIB1 to the terminal device. The first configuration information is used to indicate a first preamble related to the first request and/or a transmission resource of the target SIB1.

Optionally, the first request is transmitted based on CFRA.

Optionally, the first request includes the first preamble, and the first preamble is used by a plurality of terminal devices transmitting the first request.

Optionally, the first request includes the first preamble, the first preamble is one preamble in a first preamble group, and a preamble in the first preamble group is used by a plurality of terminal devices transmitting the first request.

Optionally, the first preamble group is one or more of the following: the first preamble group is one of at least two preamble groups used for CFRA, the at least two preamble groups further include a second preamble group, and the second preamble group is used for a random access process; or the preamble in the first preamble group is a preamble reserved for the network device.

Optionally, when the first preamble group includes a preamble group used for CFRA and a reserved preamble, the first preamble is determined based on location information of the terminal device.

Optionally, transmission of the target SIB1 is determined according to a first condition, and the first condition includes one or more of the following: whether a cell corresponding to the network device receives a first-type trigger event; a quantity of terminal devices transmitting the first request in a cell corresponding to the network device; or a measurement result of the terminal device.

Optionally, when the quantity of terminal devices is greater than a first threshold, the target SIB1 is transmitted through broadcasting; or when the quantity of terminal devices is less than or equal to a first threshold, the target SIB1 is transmitted by using downlink control information.

Optionally, the first configuration information includes one or more of the following: NES-CellId; SIB1-RequestConfig; frequencyInfoUL; pdcch-ConfigSIB1; or pdcch-ConfigOD-SIB1-RAR.

Optionally, the transmission resource of the target SIB1 includes a first time window in which the terminal device receives the target SIB1, and the first configuration information is further used to indicate a location of the target SIB1 in the first time window, or a location of the target SIB1 in the first time window is determined based on an identifier ID of a cell corresponding to the target SIB1.

Optionally, the target SIB1 corresponds to a first NES cell, and an ID of the first NES cell is used to determine a first offset of the target SIB1 in the first time window.

Optionally, the first time window is used to transmit a plurality of SIB1s including the target SIB1, and the first offset SI_{offset} satisfies:

SI_{offset}=(cell_{ID}×k)mod T.

Herein, cello is the ID of the first NES cell, k is a spacing factor related to a spacing of plurality of SIB1s in first time window, and T is a length of the first time window.

Optionally, the target SIB1 corresponds to a first NES cell, the first NES cell is one of a plurality of NES cells served by the network device, the network device corresponds to a non-NES cell that communicates with the plurality of NES cells, and at least one of the location of the target SIB1 in the first time window or a first spacing factor corresponding to the target SIB1 is determined based on a load of the first NES cell.

Optionally, the first spacing factor is adjusted based on the load of the first NES cell, and a second spacing factor k_{adjust} obtained after the first spacing factor is adjusted satisfy:

$${k}_{adjust} = {k}_{initial} * ( 1 + \frac{Q - {Q}_{adjust}}{{Q}_{max} - Q} ) .$$

Herein, kᵢₙᵢₜᵢₐₗ is an initial spacing factor, Q is a real-time load value, Q_{adjust} is an intermediate load value used to adjust the spacing factor, and Qₘₐₓ is a maximum load value of first NES cell.

Optionally, when a difference between the second spacing factor and the first spacing factor is greater than or equal to a second threshold, the second spacing factor is used to determine the location of the target SIB1 in the first time window; or when a difference between the second spacing factor and the first spacing factor is less than a second threshold, the first spacing factor is used to determine the location of the target SIB1 in the first time window.

Optionally, the first spacing factor may be further adjusted based on one or more of the following information: a priority of the first NES cell; a location of the first NES cell in coverage of the non-NES cell; or a level of an ID of the first NES cell.

Optionally, the target SIB1 corresponds to a first NES cell, a transmission resource corresponding to the target SIB1 includes a frequency resource corresponding to the first NES cell, the first NES cell is one of a plurality of NES cells served by the network device, and a plurality of SIB1s of the plurality of NES cells are respectively transmitted on different frequency resources.

Optionally, the different frequency resources are different BWPs, the first NES cell corresponds to a first BWP, and the first BWP includes a dedicated resource of the target SIB1.

Optionally, the target SIB1 corresponds to a first NES cell, the first NES cell is one cell in a first NES cell group, and a plurality of SIB1s corresponding to a plurality of NES cells in the first NES cell group are transmitted through multiplexing a first resource.

Optionally, the target SIB1 corresponds to a first NES cell, and the network device corresponds to the first NES cell, or the network device corresponds to a non-NES cell that communicates with the first NES cell.

FIG. 8 is a schematic structural diagram of a communications apparatus according to an embodiment of the present application. Dashed lines in FIG. 8 indicate that a unit or module is optional. The apparatus 800 may be configured to implement the methods described in the foregoing method embodiments. The apparatus 800 may be a chip, a terminal device, or a network device.

The apparatus 800 may include one or more processors 810. The processor 810 may support the apparatus 800 in implementing the methods described in the foregoing method embodiments. The processor 810 may be a general-purpose processor or a dedicated processor. For example, the processor may be a central processing unit (central processing unit, CPU). Alternatively, the processor may be another general-purpose processor, a digital signal processor (digital signal processor, DSP), an application specific integrated circuit (application specific integrated circuit, ASIC), a field programmable gate array (field programmable gate array, FPGA) or another programmable logic device, a discrete gate or transistor logic device, a discrete hardware component, or the like. The general-purpose processor may be a microprocessor, or the processor may be any conventional processor or the like.

The apparatus 800 may further include one or more memories 820. The memory 820 stores a program, and the program may be executed by the processor 810, so that the processor 810 performs the method described in the foregoing method embodiment. The memory 820 may be separate from the processor 810 or may be integrated into the processor 810.

The apparatus 800 may further include a transceiver 830. The processor 810 may communicate with another device or chip by using the transceiver 830. For example, the processor 810 may transmit data to and receive data from another device or chip by using the transceiver 830.

An embodiment of the present application further provides a computer-readable storage medium for storing a program. The computer-readable storage medium may be applied to the terminal device or the network device provided in embodiments of the present application, and the program causes a computer to perform the method performed by the terminal device or the network device in various embodiments of the present application.

The computer-readable storage medium may be any available medium accessible by a computer or a data storage device such as a server or a data center that integrates one or more available media. The usable medium may be a magnetic medium (for example, a floppy disk, a hard disk, or a magnetic tape), an optical medium (for example, a digital video disc (digital video disc, DVD)), a semiconductor medium (for example, a solid state drive (solid state drive, SSD)), or the like.

An embodiment of the present application further provides a computer program product. The computer program product includes a program. The computer program product may be applied to the terminal device or the network device provided in embodiments of the present application, and the program causes a computer to perform the method performed by the terminal device or the network device in various embodiments of the present application.

All or a part of the foregoing embodiments may be implemented by using software, hardware, firmware, or any combination thereof. When the software is used to implement embodiments, all or a part of embodiments may be implemented in a form of a computer program product. The computer program product includes one or more computer instructions. When the computer program instructions are loaded and executed on a computer, the procedures or functions according to embodiments of the present application are completely or partially generated. The computer may be a general-purpose computer, a dedicated computer, a computer network, or another programmable apparatus. The computer instructions may be stored in a computer-readable storage medium or transmitted from one computer-readable storage medium to another computer-readable storage medium. For example, the computer instructions may be transmitted from one website, computer, server, or data center to another website, computer, server, or data center in a wired (such as a coaxial cable, an optical fiber, and a digital subscriber line (digital subscriber line, DSL)) manner or a wireless (such as infrared, wireless, and microwave) manner.

An embodiment of the present application further provides a computer program. The computer program may be applied to the terminal device or the network device provided in embodiments of the present application, and the computer program causes a computer to perform the methods performed by the terminal device or the network device in various embodiments of the present application.

The terms “system” and “network” in the present application may be used interchangeably. In addition, the terms used in the present application are merely used to explain the specific embodiments of the present application, and are not intended to limit the present application. In the specification, claims, and accompanying drawings of the present application, the terms “first”, “second”, “third”, “fourth”, and so on are intended to distinguish between different objects but do not describe a particular sequence. In addition, the terms “include” and “have” and any variations thereof are intended to cover a non-exclusive inclusion.

In embodiments of the present application, “indicate” mentioned herein may be a direct indication, or may be an indirect indication, or may mean that there is an association relationship. For example, A indicates B, which may mean that A directly indicates B, for example, B may be obtained by using A; or may mean that A indirectly indicates B, for example, A indicates C, and B may be obtained by using C; or may mean that there is an association relationship between A and B.

In embodiments of the present application, the term “corresponding” may mean that there is a direct or indirect correspondence between two elements, or that there is an association between two elements, or that there is a relationship of “indicating” and “being indicated”, “configuring” and “being configured”, or the like.

In embodiments of the present application, “pre-defining” or “pre-configuring” can be implemented by pre-storing corresponding codes, tables, or other forms that may be used to indicate related information in devices (for example, including a terminal device and a network device). A specific implementation thereof is not limited in the present application. For example, being predefined may refer to being defined in a protocol.

In embodiments of the present application, the “protocol” may indicate a standard protocol in the communication field, which may include, for example, an LTE protocol, an NR protocol, and a related protocol applied to a future communications system. This is not limited in the present application.

In embodiments of the present application, determining B based on A does not mean determining B based on only A, but instead B may be determined based on A and/or other information.

In embodiments of the present application, the term “and/or” is merely an association relationship that describes associated objects, and represents that there may be three relationships. For example, A and/or B may represent three cases: only A exists, both A and B exist, and only B exists. In addition, the character “/” in this specification generally indicates an “or” relationship between the associated objects.

In embodiments of the present application, sequence numbers of the foregoing processes do not mean execution orders. The execution orders of the processes should be determined based on functions and internal logic of the processes, and should not be construed as any limitation on the implementation processes of embodiments of the present application.

In several embodiments provided in the present application, it should be understood that, the disclosed system, apparatus, and method may be implemented in other manners. For example, the foregoing described apparatus embodiments are merely examples. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or another form.

The units described as separate parts may be or may not be physically separate, and parts displayed as units may be or may not be physical units, and may be at one location, or may be distributed on a plurality of network elements. A part or all of the units may be selected based on actual requirements to achieve the objectives of the solutions of embodiments.

In addition, functional units in embodiments of the present application may be integrated into one processing unit, or each of the units may exist alone physically, or two or more units may be integrated into one unit.

The foregoing descriptions are merely specific implementations of the present application, but the protection scope of the present application is not limited thereto. Any variation or replacement readily figured out by a person skilled in the art within the technical scope disclosed in the present application shall fall within the protection scope of the present application. Therefore, the protection scope of the present application shall be subject to the protection scope of the claims.

What is claimed is:

1. A wireless communication method, comprising:
receiving, by a terminal device, first information, wherein the first information is related to a trigger request of a target on-demand system information block 1 (SIB1);
transmitting, by the terminal device, a first request to a network device, wherein the first request is used to request the target on-demand SIB1; and
receiving, by the terminal device, the target on-demand SIB1 from the network device, wherein the first information indicate at least one of a first preamble related to the first request, PRACH resources related to the first request, or a transmission resource of the target on-demand SIB1.

2. The method according to claim 1, wherein the transmitting, by the terminal device, a first request to a network device further comprises:
transmitting, by the terminal device, the first request based on contention-free random access (CFRA).

3. The method according to claim 1, wherein the first request comprises the first preamble, and the first preamble is used by a plurality of terminal devices transmitting the first request.

4. The method according to claim 1, wherein the first request comprises the first preamble, the first preamble is one preamble in a first preamble group, and one or more preambles in the first preamble group is used by a plurality of terminal devices transmitting the first request.

5. The method according to claim 4, wherein the first preamble group is one or more of following:
the first preamble group is one of at least two preamble groups used for CFRA, the at least two preamble groups comprise a second preamble group, and the second preamble group is used for a random access process; or
the preamble in the first preamble group is a preamble reserved for the network device.

6. The method according to claim 5, wherein when the first preamble group comprises a preamble group used for CFRA and a reserved preamble, the first preamble is determined based on location information of the terminal device.

7. The method according to claim 1, wherein transmission of the target SIB1 is determined according to a first condition, and the first condition comprises one or more of following:
whether a cell corresponding to the network device receives a first-type trigger event;
a quantity of terminal devices transmitting the first request in a cell corresponding to the network device; or
a measurement result of the terminal device.

8. The method according to claim 7, wherein when the quantity of terminal devices is greater than a first threshold, the target SIB1 is transmitted through broadcasting; or when the quantity of terminal devices is less than or equal to a first threshold, the target SIB1 is transmitted by using downlink control information.

9. The method according to claim 1, wherein the first information comprises one or more of following:
NES-CellId;
SIB1-RequestConfig;
frequencyInfoUL;
pdcch-ConfigSIB1; or
pdcch-ConfigOD-SIB1-RAR.

10. The method according to claim 1, wherein
the transmission resource of the target SIB1 comprises a first time window in which the terminal device receives the target SIB1, and the first information indicates a location of the target SIB1 in the first time window; or
a location of the target SIB1 in the first time window is determined based on an identifier (ID) of a cell corresponding to the target SIB1.

11. The method according to claim 10, wherein the target SIB1 corresponds to a first network energy saving (NES) cell, and an ID of the first NES cell is used to determine a first offset of the target SIB1 in the first time window.

12. The method according to claim 11, wherein the first time window is used to transmit a plurality of SIB Is comprising the target SIB1, and the first offset SI_{offset} satisfies:
SI_{offset}=(cell_{ID}×k)mod T, wherein
cell_{ID} is the ID of the first NES cell, k is a spacing factor related to a spacing of the plurality of SIB1s in the first time window, and T is a length of the first time window.

13. The method according to claim 10, wherein the target SIB1 corresponds to a first NES cell, the first NES cell is one of a plurality of NES cells served by the network device, the network device corresponds to a non-NES cell that communicates with the plurality of NES cells, and at least one of the location of the target SIB1 in the first time window or a first spacing factor corresponding to the target SIB1 is determined based on a load of the first NES cell.

14. The method according to claim 13, wherein the first spacing factor is adjusted based on the load of the first NES cell, and a second spacing factor k_{adjust} obtained after the first spacing factor is adjusted satisfy:
$${k}_{adjust} = {k}_{initial} * ( 1 + \frac{Q - {Q}_{adjust}}{{Q}_{max} - Q} )$$
wherein
kᵢₙᵢₜᵢₐₗ is an initial spacing factor, Q is a real-time load value, Q_{adjust} is an intermediate load value used to adjust the spacing factor, and Qₘₐₓ is a maximum load value of the first NES cell.

15. The method according to claim 14, wherein
when a difference between the second spacing factor and the first spacing factor is greater than or equal to a second threshold, the second spacing factor is used to determine the location of the target SIB1 in the first time window; or
when a difference between the second spacing factor and the first spacing factor is less than a second threshold, the first spacing factor is used to determine the location of the target SIB1 in the first time window.

16. The method according to claim 13, wherein the first spacing factor is further adjusted based on one or more of following information:
a priority of the first NES cell;
a location of the first NES cell in coverage of the non-NES cell; or
a level of an ID of the first NES cell.

17. The method according to claim 1, wherein the target SIB1 corresponds to a first NES cell, a transmission resource corresponding to the target SIB1 comprises a frequency resource corresponding to the first NES cell, the first NES cell is one of a plurality of NES cells served by the network device, and a plurality of SIB1s of the plurality of NES cells are respectively transmitted on different frequency resources.

18. The method according to claim 17, wherein the different frequency resources are different bandwidth parts (BWPs), the first NES cell corresponds to a first BWP, and the first BWP comprises a dedicated resource of the target SIB1.

19. The method according to claim 1, wherein the target SIB1 corresponds to a first NES cell, the first NES cell is one cell in a first NES cell group, and a plurality of SIB1s corresponding to a plurality of NES cells in the first NES cell group are transmitted through multiplexing a first resource.

20. The method according to claim 1, wherein
the target SIB1 corresponds to a first NES cell, and the network device corresponds to the first NES cell, or
the network device corresponds to a non-NES cell that communicates with the first NES cell.
